(19) United States
(12) Patent Application Publication
(10) Pub. No.: US 2002/0014116 A1
(43) Pub. Date: Feb. 7, 2002

(54) Methods and systems for measuring crop density

(76) Inventors: Ronald H. Campbell, Mendon, UT (US); Ivan Bogoev, Logan, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/946,707

(22) Filed: Sep. 4, 2001

Related U.S. Application Data
(62) Division of application No. 09/258,667, filed on Feb. 26, 1999.

(51) Int. Cl. G01F 17/00; G01N 9/00

(52) U.S. Cl. 73/149; 73/32 R

(57) ABSTRACT

System and methods for measuring the density of harvested crops or other material carried by a conveyor incorporate a linear array of ultrasonic distance sensors oriented at an acute angle to detect the height of harvested crops carried on the conveyor. The height measurements are used to calculate instantaneous cross-sectional areas of the harvested crops. The weight of the crops is measured by a load cell as the crops are carried on the conveyor. The density of the crops is finally calculated, using a processing means, based on the cross-sectional area measurement, the speed of the conveyor, and the measured weight of the crops.

### CROSS-REFERENCE TO RELATED APPLICATIONS

This application is a divisional of U.S. patent application Ser. No. 09/258,667, filed Feb. 26, 1999, which is incorporated herein by reference.

### BACKGROUND OF THE INVENTION

1. The Field of the Invention

The present invention relates generally to the field of machine harvesting of crops wherein the harvested material is moved through the harvester on a belted conveyor. More particularly, the present invention relates to a system and method for measuring the amount (mass and/or volume) of crop harvested per unit area of cropland.

2. Background and Related Art

Mechanical harvesters, incorporating the use of belted chain, rubber belt, and/or paddle chain conveyors, are used by agricultural producers to harvest such crops as potatoes, sugar beets, grapes, tomatoes, cirrus fruit, ear corn, onions and the like. Typically, these mechanical harvesters are for the harvesting of crops other than grain.

These mechanical harvesters for non-grain crops typically incorporate some type of crop pickup mechanism to move the crop from the field onto the harvesters. For example, potato harvesters move a blade in front of a primary belted chain, just underneath potatoes in the field. As the potatoes are moved onto the primary chain, they are usually accompanied by soil and vines. The primary chain allows soil to fall away from the potatoes as they are moved through the harvester, thus separating unwanted material (called “tare”) from the desired product during the harvest process. On potato harvesters, the harvest stream is moved onto a deviner chain, which allows the potatoes to fall through to a secondary belted chain, leaving the potato vines to be carried off the harvester and dropped back to the ground. Somewhere in the product flow stream an air blower is often placed to further remove unwanted field material from the potatoes.

Mechanical harvesters for other crops, such as sugar beets, use other techniques to clean the harvested product on its way to the tending truck, trailer, or gondola traveling alongside or behind these harvesters. Some employ people riding on the harvester to identify and remove unwanted materials before the crop is loaded onto the accompanying tender. On mechanical tomato harvesters for processed tomatoes, up to two sets of electronic sorters are installed. One rejects dirt clods, while the other is a color sorter to reject green tomatoes. In addition, workers can be located on these harvesters to further reject unwanted materials or substandard produce in the crop stream.

In recent years, measurement of the yield of harvested crops has been facilitated by “on-the-go” geo-referenced systems that weigh and record non-grain crop flows on conveyor-equipped mechanical harvesters. Such detailed yield measurement can be used to determine the weight or volume of the crop contained in a tender accompanying the mechanical harvester and can also be used to create yield maps of the harvested

One technique that has been used to weigh crops as they are harvested involves replacing the standard idler wheels that bear the belted chain close to the discharge section of the harvester with an idler wheel supported on a load cell. The load cell generates a measurement of the weight of the product along a segment of the conveyor. This measurement represents a weight of the product per unit distance. A belt speed sensor is installed on the drive shaft to furnish a measure of the rate of product traveling over the weighed section of the conveyor. The product of the weight per unit distance and the rate of the product movement gives the weight flow rate of the product over the conveyor. This weighing system represents one example of the conventional techniques that have been used to weigh crops. Many of these techniques utilize load cells or other force sensors that can require significant calibration and maintenance in the field.

To calculate the weight of the crop accumulated in the tender vehicle (e.g., truck, trailer, or gondola) alongside the harvester, the product flow rate can be integrated with respect to time beginning with the empty tender. For computation of yields, the flow rate is divided by the area covered by the harvester per unit time of the harvester. The area covered by the harvester per unit time can be calculated by multiplying the harvester's swath width and the harvester speed. In practice, both the load information and the yield data are useful to the grower in the optimization of the agricultural operation.

The foregoing technology has evolved into commercially available yield or load monitors and yield map data collection systems. Through multiple seasons of commercial use, certain problems have become apparent. For instance, in many crop and/or soil conditions, particularly when harvesting potatoes, a significant amount of unwanted material, or tare, still makes its way onto the material being transported from the field. As a result, yield and load measurements obtained using conventional systems are unreliable in situations where a significant amount of tare material is present on the conveyor.

In view of the foregoing, it would also be an advancement in the art to provide systems for measuring the volume or weight of harvested crops that do not require load cells or other conventional force sensors. Such systems would eliminate many of the components otherwise used in prior art systems that often require significant calibration and maintenance.

It would also be desirable to provide weighing techniques that compensate for tare material interspersed with harvested crops. Doing so would allow accurate and reliable yield and load measurements to be obtained for harvested potatoes and other crops. Such tare-corrected data values could be used to make accurate yield maps. Moreover, systems that could determine the amount of tare material in a tender load leaving the field could allow the load to be appropriately and efficiently routed when it reaches the processing plant or crop storage facility.

### BRIEF SUMMARY OF THE INVENTION

The present invention relates to crop measurement systems and methods for use with a mechanical crop harvester that includes a belted conveyor. The crop measurement system includes a height sensor assembly positioned over and across the crop flow conveyor for sampling the height of the crop as it carried by the conveyor. As the crop passes under the height sensor assembly, the height of the crop with respect to the conveyor is measured at selected points. For example, the height sensor assembly can include an array of ultrasonic or other distance sensors, each of which repeatedly generates a height measurement. The height measurements made by the distance sensors at any moment can be used to approximate the cross sectional area of the crops passing under the height sensor assembly.

The crop measurement systems can further include a conveyor speed sensor, which can be a sensor that measures the rotational motion of the drive shaft of the conveyor assembly. The product of the conveyor speed and the cross sectional area at any moment represents an instantaneous volume flow rate of the crops. The volume flow rate, when repeatedly calculated, can be used to determine the volume of crops harvested over a selected period of time. Similarly, the volume flow rate can be multiplied by a designated or assumed density of the crops to give a mass flow rate of the crops, which in turn provides a harvested crop load or weight when multiplied by a selected period of time. This technique is most accurate when the assumed density can be designated with some degree of confidence.

The systems and methods of the invention for calculating the weight of harvested crops is in many ways simpler than those of the prior art. For instance, the weight can be calculated without using load cells or other conventional force sensors. The invention eliminates many of the expensive components of previously existing systems, which often required significant calibration and maintenance.

In another implementation, the invention is capable of compensating for tare material interspersed with the harvested crops, thereby allowing the weight of the crops to be accurately measured. This feature is particularly useful for measuring yields of potatoes or other crops that traditionally are harvested along with substantial quantities of soil and unwanted plant material. The tare material and the crops typically have different, predictable densities. If the actual density of the material can be determined, the volume and weight ratios of crops to tare material in the material carried by the conveyor can be calculated. The actual density of the material can be calculated by determining the volume (i.e., using the height sensor assembly and the conveyor speed sensor) and by obtaining an independent, direct measure of the weight of the material. For example, an idler wheel equipped with a load cell can generate the weight measurement.

The invention also extends to the apparatus for measuring the cross-sectional area of the material carried by the conveyor, including the height measurement assembly. The distance sensors in the height measurement assembly can be analog ultrasonic distance sensors. The number of sensors is typically no less than three, and can be as many as desired. Ultrasonic sensors generally have a minimum spatial requirement in order to prevent interference one with another. The array of distance sensors can often have a length greater than the width of the conveyor. In this case, the array of distance sensors can be oriented diagonally or at an acute angle with respect to the direction of motion of the conveyor. Such orientation of the array is valid due to the fact that there is usually insignificant cross-conveyor movement of the material as it is carried by the conveyor.

The invention extends to systems and methods for creating yield maps of harvested crops that employ the weight measurement techniques disclosed herein. For instance, a global positioning system (GPS) can generate the data representing the position of the harvester, while the weight or volume measurements to be plotted on the map are generated using the techniques disclosed herein.

Additional objects and advantages of the invention will be set forth in the description which follows, and in part will be obvious from the description, or may be learned by the practice of the invention. The objects and advantages of the invention may be realized and obtained by means of the instruments and combinations particularly pointed out in the appended claims. These and other objects and features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 illustrates a conveyor assembly equipped with a distance sensor array and a shaft speed sensor, thereby allowing the volume and/or the weight of harvested crops to be measured.

FIG. 2 is a perspective view illustrating the array of distance sensors being used to measure the height of a material carried by a conveyor.

FIG. 3 is a top view of the array of distance sensors of FIG. 2.

FIG. 4 is a partial-elevation view of an array of distance sensors being used to measure the cross-sectional area of a material including crop material and tare material carried on a conveyor.

FIG. 5 illustrates a conveyor assembly equipped with a distance sensor array, a shaft speed sensor, and an idler wheel having a load cell attached thereto, thereby allowing the volume and/or the weight of harvested crops to be measured.

FIG. 6 is a schematic diagram illustrating selected components of a system for measuring a weight and/or the volume of harvested crops.

### DETAILED DESCRIPTION OF THE PREFERRED EMBODIMENTS

The present invention relates to crop measurement systems and methods for use with a mechanical crop harvester that includes a belted conveyor. According to the invention, crops or other material carried by the conveyor are passed under a height sensor assembly that measures the height of the crops with respect to the conveyor. The cross-sectional area measurement and the speed of the conveyor enable the instantaneous volume flow rate of the crops to be calculated. The invention can further provide weight flow rate and weight measurements of the harvested crops by multiplying the volume flow rate with an expected density of the crops. The crop measurement systems of the invention can include load cells or other devices or systems for directly measuring the weight of the material carried on the conveyor. An estimated tare weight can be subtracted from the weight of the material, yielding an estimate of the weight of the crops. While the invention is described herein primarily in the context of measuring crops, those skilled in the art will recognize that substantially any material capable of being carried by a conveyor can be measured.

### Volume and Weight Measurements

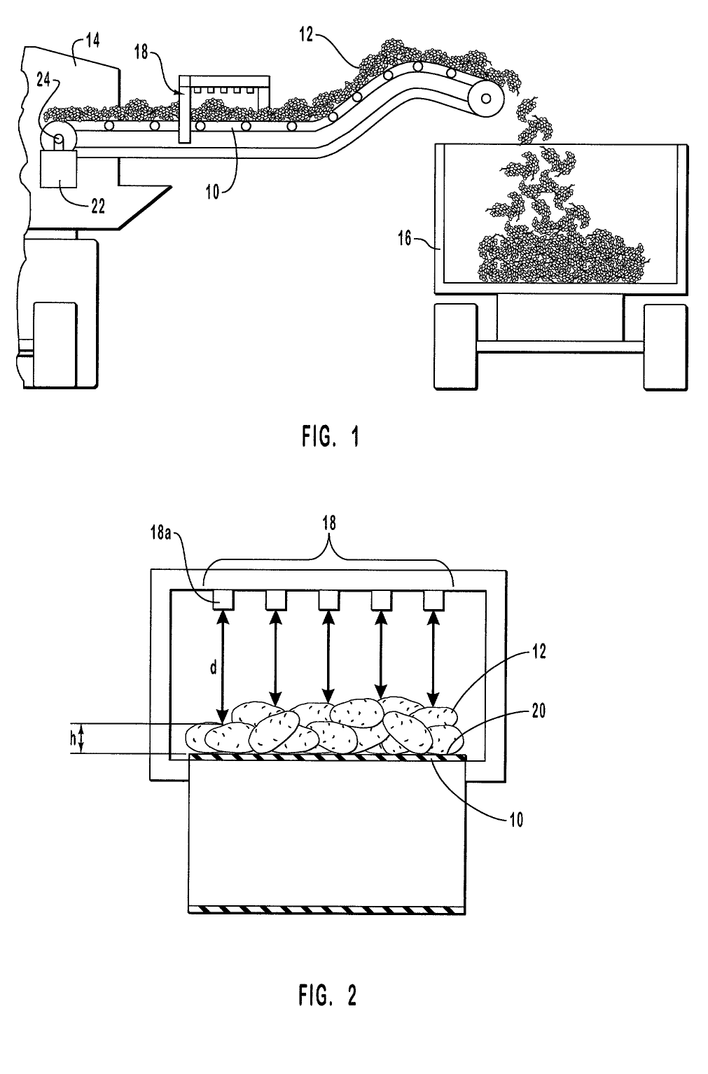

FIG. 1 illustrates a conveyor assembly equipped with one embodiment of the crop measurement systems of the invention. While conveyor 10 of FIG. 1 is a belted conveyor for use in harvesting crops 12, such as grapes, potatoes, etc., the invention can be adapted to other conveyors. Conveyor 10 is attached to harvester 14 that removes crops from the field and places them on the conveyor. Conveyor 10 carries crops 12 to a tender 16, which may be a truck, a trailer, a gondola, or the like that receives the harvested crops. As crops 12 are carried by conveyor 10, they pass under an array of distance sensors 18. Distance sensors 18 repeatedly make height measurements of crops 12 with respect to the surface of conveyor 10.

FIG. 2, further illustrates the array of distance sensors 18 and the techniques for taking height measurements. In this embodiment, distance sensors 18 are analog, ultrasonic sensors, each capable of detecting the distance between it and an object (e.g., crops 12). For instance, distance sensor 18A emits an ultrasonic signal that enables it to measure the distance, d, between distance sensor 18A and the surface of crops 12 as shown in FIG. 2. Because the distance between distance sensor 18A and surface 20 of conveyor 10 is generally constant, distance d can be easily correlated to height, h, of crops 12 as shown in FIG. 2.

In this embodiment, distance sensors 18 make periodic measurements of the height of crops 12 at discrete points along the width of conveyor 10. A series of discrete height measurements as shown in FIG. 2 can be used to approximate the cross-sectional area of crops 12 along a cross-section defined by the array of distance sensors 18. The number of distance sensors 18 in the array should be enough to approximate the cross-sectional area of crops 12 with as much accuracy as desired, considering the cost of the distance sensors and the increasing complexity of the array as more distance sensors are added thereto. In practice, three to five distance sensors 18 are often adequate. Those skilled in the art will understand the techniques that can be used to approximate the cross-sectional area upon obtaining a plurality of height measurements of crops 12.

Returning to FIG. 1, the speed of conveyor 10 can be measured to calculate an instantaneous volume flow rate of crops 12 upon obtaining the approximation of the cross-sectional area. In this embodiment, the conveyor speed is measured by a shaft speed sensor 22 that is coupled to a drive shaft 24 of conveyor 10 and measures an angular speed of the drive shaft as conveyor 10 moves. Shaft speed sensor represents one example of means for sensing a speed of the conveyor. Other methods of measuring the speed of conveyor 10 can alternatively be used.

Equation 1 represents one way of calculating the instantaneous volume flow rate, Q, based on the cross-sectional area A of crops 12 and the speed S of conveyor 10:

Q=A×S 1)

As crops 12 are carried by conveyor 10, array of distance sensors 18 can be repeatedly used to calculate cross-sectional areas of crops 12. For instance, ultrasonic sensors, when used as distance sensors 18, can sustain a measurement rate of up to 100 measurements per second.

The volume of crops 12 that has passed under array of distance sensors 18 during a selected period of time can be calculated or estimated by integrating the volume flow rate with respect to time or by approximating this integral using a set of discrete volume flow rate measurements. The expression

$${V}_{C} = {\sum }_{n = 1}^{k} {Q}_{n} t \qquad 2 )$$

represents an approximation of the crop volume, V_{c}, that passes under the array of distance sensors 18 during a period of time having a length of k×t. For example, if the distance sensors 18 operate at 15 Hz, t=1/15 sec. If the period of time during which the volume of crops 12 is to be measured is 60 seconds, k in Equation 2 is 1800 (i.e., 60 sec×15).

Measuring the volume flow rate and the volume of crops 12 in the foregoing manner can result in useful crop yield information. This is particularly true for crops that are traditionally measured by volume instead of weight.

The assembly of FIG. 1 can also be used to measure or estimate the weight of crops 12 as they are harvested. Many crops have a relatively uniform expected density. The expected density of the crops represents a designated crop density that can be used to estimate the weight flow rate or the weight of the harvested crops. For example, in Equation 3, the designated density of the crops, ρ_{c}, and the volume flow rate of the crops, Q, yield an estimated mass flow rate (or weight flow rate), W′_{c}, of the crops at a selected instant in time.

W′_{c}Q×ρ_{c} 3)

Similarly, ρ_{c} and the volume V_{c} of the crops can be used to calculate the mass (or weight), W_{c}, of the harvested crops during a selected period of time as shown in Equation 4:

W_{c}=V_{c}×ρ_{c} 4)

W′_{c}, W_{c}, and other related values used below (e.g., Wₘ and Wₜ) will be referred to hereinafter as representing weight flow rates or weights, although it is recognized that the density ρ_{c} of crops is typically expressed in terms of unit mass per unit volume such that Equations 3 and 4 can be described as yielding a mass value and a mass flow rate value. Furthermore, any reference herein to a weight or a weight flow rate encompasses the corresponding mass or mass flow rate.

The accuracy of the weight measurements obtained in the foregoing manner depends largely on the accuracy of the designated crop density. Thus, using a designated density to estimate crop weights can be expected to give a value that deviates from the actual weight of the harvested crops. Depending on the expected deviation, the foregoing techniques may or may not be preferred for calculating an overall weight for harvested crops, such as the weight of crops transported to tender 16 of FIG. 1. However, the foregoing methods can generally be successfully used to generate useful yield maps of harvested crops. Yield maps can provide valuable information to agricultural producers merely by depicting the relative crop yield variation across a tract of cropland. For instance, a crop yield map showing that a certain portion of a field yields 25% less than adjacent portions can be valuable, even though the mapped crop yield at any particular point in the field might deviate from the actual crop yield by several percent.

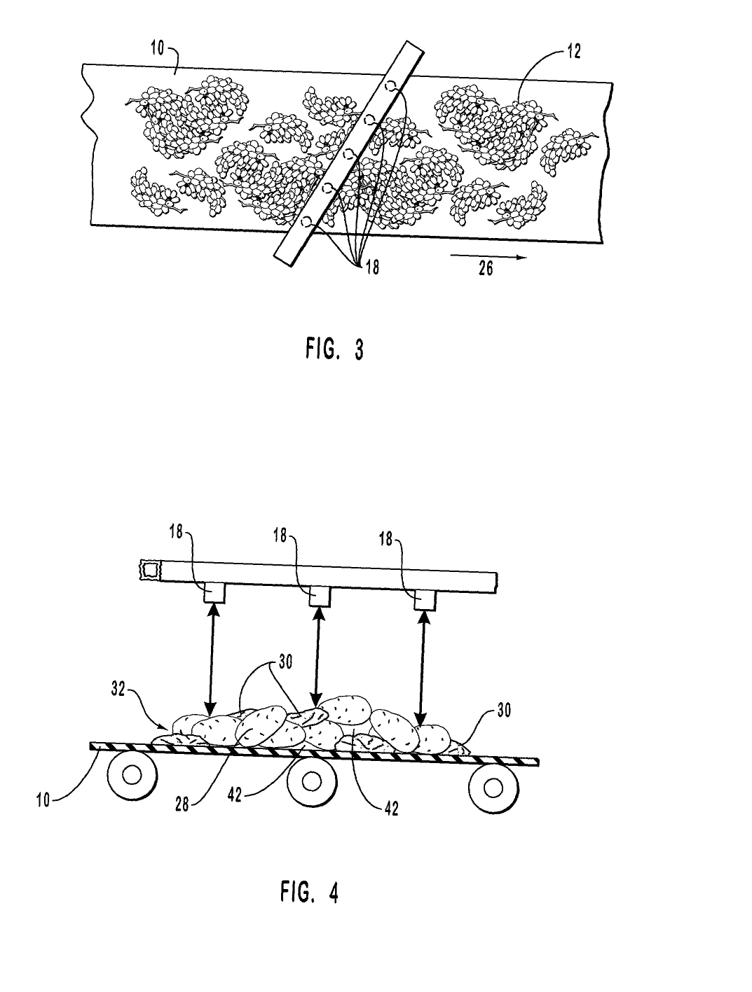

Referring to FIG. 2, analog ultrasonic distance sensors typically have a minimum spatial requirement needed to ensure reliable operation. If distance sensors 18 are spaced too close together, they may interfere one with another, thereby affecting the reliability of the height measurements. Depending on the width of conveyor 12 and the desired number of distance sensors 18 to be included in the array, the array may need to be oriented at an acute angle with respect to the direction of travel (shown at 26) of conveyor 10 as illustrated in FIG. 3. Crops typically experience little cross-conveyor motion as they are carried by the conveyor. Thus, the diagonal orientation of the array of distance sensors 18 as shown in FIG. 3 generally provides valid cross-sectional area measurements. To further illustrate, each of the five distance sensors 18 of FIG. 2 takes a height measurement of crops 12 at a point that can be considered to be representative of roughly one-fifth of the width of conveyor 10 for purposes of calculating the cross-sectional area, regardless of whether the five distance sensors 18 are aligned perpendicularly or at an acute angle with respect to the direction of travel of conveyor 10.

### Weight Measurements Including Tare Correction

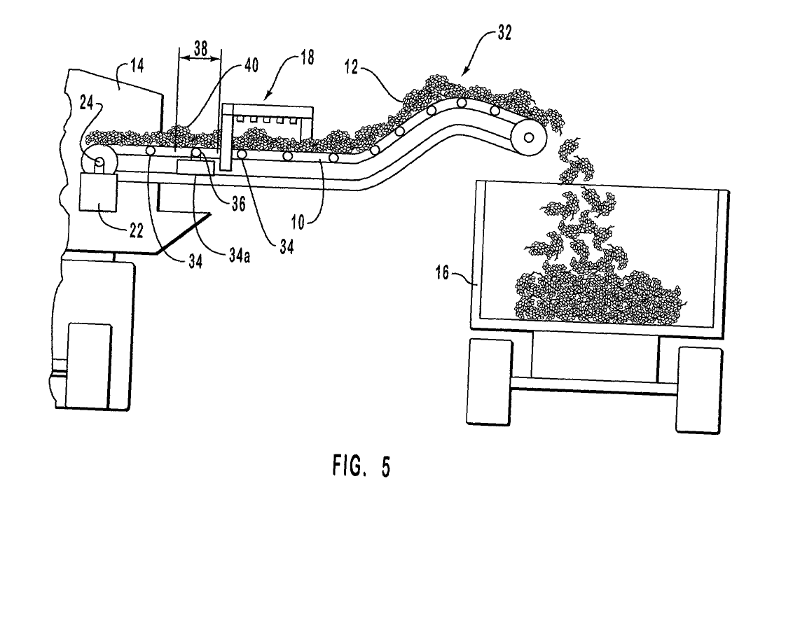

FIG. 4 is a partial view of the array of distance sensors 18 set at an acute angle with respect to the direction of travel of conveyor 10 being used to measure a material carried on conveyor 10 that includes product 28 and tare material 30. In this example, product 28 is the crop material (e.g., potatoes), while tare material 30 comprises soil, plant matter, and other non-potato matter. Potato harvesting is but one example of the harvesting processes that can gather a significant amount of tare material in addition to the crop material. Conventional crop weighing techniques for weighing material 32 of FIG. 4 do not distinguish between crop material 28 and tare material 30. For example, simply measuring the weight of material 32 includes the weight of crop material 28 and tare material 30. Similarly, if material 32 were to be measured with the system described above in reference to FIG. 1, the cross-sectional area, the volume, and the weight measurements might not adequately distinguish between the contribution of crop material 28 and tare material 30. In particular, because crop material 28 and tare material 30 generally do not have the same density, the overall density of material 30 cannot be accurately predicted unless one knows the ratio of crop material 28 to tare material 30 and the expected densities of crop material 28 and tare material 30.

The embodiment depicted in FIGS. 4 and 5 can correct or compensate for the tare material 30, thereby estimating the volume or weight of crop material 28. In this embodiment, the array of distance sensors 18 and the conveyor speed sensor 22 operate to calculate the volume flow rate, Qₘ, and volume Vₘ of material 32 in a manner similar to that described above in reference to calculating the volume flow rate of crops 12 in FIG. 1. In this embodiment, instead of estimating the weight of material 32 based on a designated density of material 32, the weight selected volume of material 32 is measured directly using a load cell or another force sensor. Crop material 28 and tare material 30 can each be assigned a designated density that generally closely corresponds to the actual density. For instance, potatoes typically have a specific gravity in a range from about 1.03 to about 1.07, whereas tare material associated with potato harvesting often has a specific gravity of about 2.00.

Weight measurement can be performed according to any one of a number of techniques. FIG. 5 illustrates a conveyor assembly in which one of the idle rollers 34 that support conveyor 10 is replaced with an idle roller 34A supported by a load cell 36. Load cell 36 measures the weight of material 32 that lies within a segment 38 of conveyor 10 as shown in FIG. 5. In particular, segment 38 extends in both directions from idle roller 34A to the midpoint between idle roller 34A and the adjacent idle rollers 34. Alternatively, the weight measurement of material 32 can be performed according to the methods disclosed in pending U.S. patent application Ser. No. 09/060,528, filed Apr. 15, 1998, entitled System for Weighing Material on a Conveyor, which is hereby incorporated by reference for purposes of disclosure. The foregoing structures and systems for obtaining weight measurements represent examples of means for sensing a weight of at least a portion of the material carried on the conveyor.

The overall density, ρₘ, of material 32 can be calculated using Equation 5:

ρₘ=Wₘ/Vₘ 5)

Equation 5 is valid when the quantity of material having weight, Wₘ, is same as the quantity of material having volume Vₘ. For instance, if the weighing system of FIG. 5 is used, the quantity of material 32 that has weight Wₘ is the portion 40 lying over segment 38. In this case, the corresponding volume, Vₘ, can be measured as portion 40 later (or earlier, depending on the position of idle roller 34A) passes under array of distance sensors 18. Alternatively, Wₘ can be measured for portion 40, while volume, Vₘ, can be measured for the portion of material 32 that is simultaneously carried under array of distance sensors 18 along a length of conveyor 10 that is the same as the length of segment 38.

With density ρₘ now calculated, the volumetric ratio x_{c} of crop material 28 to material 32 can now be calculated using, for example, Equation 6:

$${X}_{C} = \frac{{ρ}_{m} - {ρ}_{t}}{{ρ}_{p} - {ρ}_{t}} \qquad 6 )$$

From this ratio, the volume, V_{c}, of crop material 28 harvested during a selected period of time can be determined based on the measured volume Vₘ of material 32 as shown in Equation 7:

V_{c}=Vₘ×x_{c} 7)

The weight W_{c} of crop material 28 that passes under the array of distance 18 during a selected period of time can be calculated according to Equation 8:

W_{c}−V_{c}×ρ_{c} 8)

Equivalently, weight W_{c}, can be calculated using Equation 9, which computes the crop weight directly from the designated density ρ_{c} of crop material 28, the designated density ρₜ of tare material 30, and the volume Vₘ and weight Wₘ of material 32.

$${W}_{c} = {ρ}_{c} [ \frac{{W}_{m} - ( {ρ}_{t} \times {V}_{m} )}{{ρ}_{c} - {ρ}_{t}} ] \qquad 9 )$$

Volume flow rates, weight flow rates, and other desired crop measurements can be calculated according to this embodiment in a similar fashion according to methods that will be understood by those skilled in the art upon learning of the disclosure made herein.

In some crop harvesting situations, it may be found that the material 32 contains a significant amount of airspace 42 illustrated in FIG. 4. Because the volume measurements made using the array of distance sensors 18 includes airspaces 42, accurate weight measurements of crop material 28 according to this embodiment may sometimes need to compensate for the packing ratio of material 32 in addition to the tare weight. Equation 10 represents the volumetric ratio x_{c}, of crop material 28 to material 32, where rₚ is the packing ratio. For instance, if 10% of the volume measured by array of distance sensors 18 is airspace 42, the packing ratio would be 0.9.

$${x}_{c} = \frac{{ρ}_{m} - ( {ρ}_{t} \times {r}_{p} )}{( {ρ}_{c} - {ρ}_{t} ) {r}_{p}} \qquad 10 )$$

The packing ratio rₚ used in Equation 10 can have a designated or expected value.

Based on the ratio x_{c} calculated according to Equation 10, the volume, volume flow rate, weight, and weight flow rate can be calculated. Moreover, Equation 11 represents a method for calculating weight, W_{c}, of crop material 28 based solely on the designated density ρ_{c} of crop material 28, the designated density ρ_{c} of tare material 30, the designated packing ratio rₚ, and the volume vₘ and weight Wₘ material 32.

$${W}_{c} = {ρ}_{c} [ \frac{{W}_{m} - ( {ρ}_{t} \times {r}_{p} )}{{r}_{p} ( {ρ}_{c} - {ρ}_{t} )} ] \qquad 11 )$$

It should be understood that the equations listed herein are merely representative of the various techniques and computational methods that can be used to calculate volumes, volume flow rates, weights, weight flow rates, and other measures of crop yields. Other techniques and computational methods will be understood by those skilled in the art upon learning of this disclosure, and are included within the scope of the invention. The designated values of ρ_{c}, ρₜ, rₚ, and the like can be selected based on values found in reference materials, experimentally, or by other techniques. In order to more closely approximate the actual density values using the designated density values, the density of the crops and the tare can be manually or otherwise measured in a particular field one or more times before, during or after harvesting. Alternatively, the designated density of the crops and the tare can have fixed values that are consistently used regardless of the particular field where the invention is practiced.

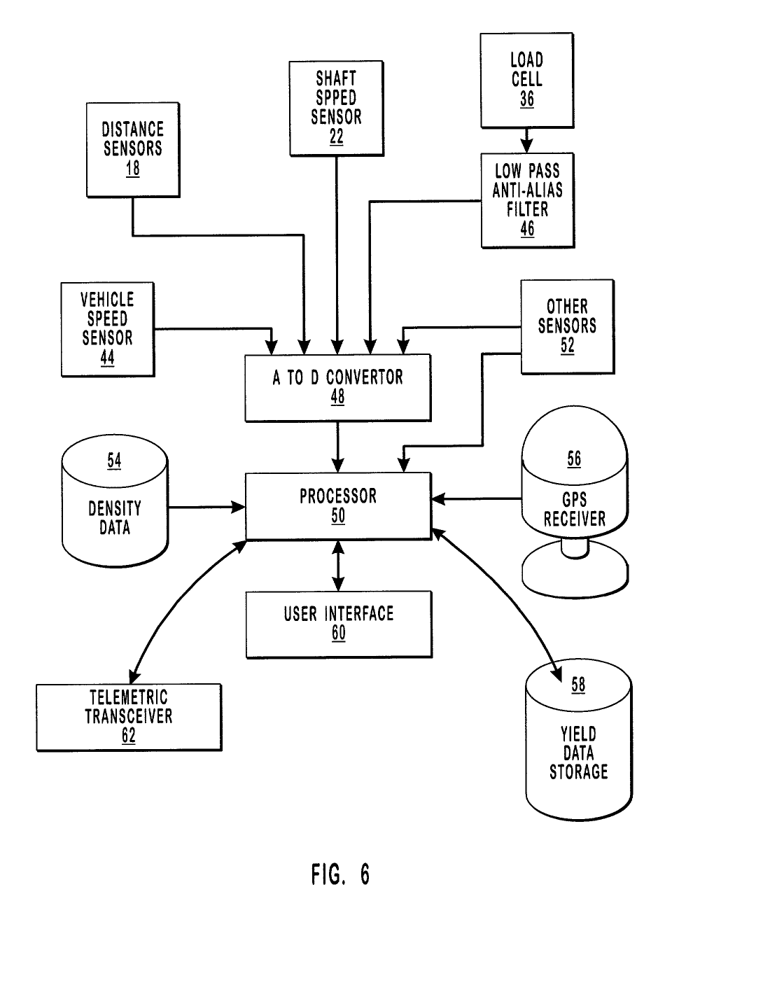

FIG. 6 is a schematic diagram illustrating the components of one embodiment of crop measurement systems of the invention. The crop measurement system of FIG. 6 is capable of compensating for the weight of the tare material in a similar manner as has been described herein in reference to FIGS. 4 and 5. The system includes distance sensors 18, a shaft speed sensor 22, and one or more load cells 36 as has been previously described. The system further includes a vehicle speed sensor 44 that enables the crop yield to be measured on a per unit area basis and plotted in a map. For instance, vehicle speed sensor may be mounted on harvester 14 (FIG. 5) to measure the speed of the harvester. The product of the speed of harvester 14 and the width of the swath harvested by harvester 14 represents the area of the cropland per unit time from which the crops are harvested.

The signal generated by load cell 36 can be advantageously processed by a low pass anti-alias filter 46 to filter out much of the noise that might be generated as the harvester vibrates and traverses uneven terrain. The signals from distance sensors 18, shaft speed sensor 22, load cell 36, and vehicle speed sensor 44 are passed through an analog-to-digital converter 48 and are transmitted to processor 50. The system might also include other sensors 52, one example of which could be a color sensor for distinguishing between tomatoes or other crops of varying degrees of ripeness. Depending on the nature of other sensors 52, the signals generated thereby may pass through analog-to-digital converter 48 or directly to processor 50.

Processor 50 can be any suitable general-purpose computer, special-purpose computer, or other processing device that executes instructions to perform the steps of the invention that include calculations or data storage. Thus, processor 50 represents one example of processor means for performing these steps. Processor 50, having received the signals from the various components of the system and having access to designated density data 54, calculates the volume or weight measurements according to the techniques disclosed herein. Processor 50 can also generate a yield map based on the volume or weight measurements, vehicle speed sensor 44 and positional data generated by a GPS receiver 56. The volume or weight data or the yield map can be stored in a yield data store 58 later retrieved for use or can be displayed to a user by means of user interface 60.

FIG. 6 illustrates an optional feature of the invention, whereby a telemetric transceiver 62 transmits crop yield data or other related information to a remote location, such as a processing plant. In one example, telemetric transceiver 62 sends data relating to the yield, density, and/or color characteristics of tomatoes to a tomato processing plant, thereby enabling the operators of the processing plant to prepare for the arrival of the tender that contains the tomatoes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for measuring the density of a material carried on a conveyor, comprising the acts of:
obtaining a cross sectional area measurement of the material at a selected cross section thereof;
measuring a speed of the conveyor;
measuring a weight of at least a portion of the material; and
calculating a density of the material based on the cross-sectional area measurement, the speed of the conveyor, and the weight.

2. A method as defined in claim 1, wherein the step of obtaining a cross-sectional area measurement of the material comprises the acts of:
passing the material under an array of distance sensors as the material is carried by the conveyor;
obtaining a plurality of height measurements of the material with respect to the conveyor, wherein each of the height measurements is obtained by one of the distance sensors of the array; and
estimating the cross-sectional area measurement based on the height measurements.

3. A method as defined in claim 1, wherein the material includes product and tare, the product having a designated product density and the tare having a designated tare density, the method further comprising the act of estimating the weight of the product.

4. A method as defined in claim 3, wherein the step of estimating the weight of the product comprises the acts of:
based on the estimated density of the material, the designated product density and the designated tare density, estimating a weight ratio of product to tare; and
based on the weight ratio and the weight of the material, estimating a weight of the product.

5. A method as defined in claim 3, wherein the material is assumed to have a designated packing ratio, the act of estimating the weight of the product comprising the steps of:
based on the estimated density of the material, the designated product density, the designated tare density, and the designated packing ratio, estimating a weight ratio of product to tare; and
based on the weight ratio and the weight of the material, estimating a weight of the product.

6. A method as defined in claim 3, wherein the product is a harvested crop, the method further comprising the act of selecting the designated density by measuring the density of a sample of the harvested crop.

7. A method as defined in claim 1, wherein estimating the density of the material comprises the act of calculating, using a processing means, the density of the material based on the cross-sectional area measurement, the speed of the conveyor, and the weight.

8. A method for measuring the density of a material carried on a conveyor, comprising the acts of:
obtaining a cross sectional area measurement of the material at a selected cross section thereof;
measuring a speed of the conveyor;
measuring a weight of at least a portion of the material;
passing the material under an array of distance sensors as the material is carried by the conveyor;
obtaining a plurality of height measurements of the material with respect to the conveyor, wherein each of the height measurements is obtained by one of the distance sensors of the array;
estimating, using a processing means, the cross-sectional area measurement based on the height measurements; and
estimating, using a processing means, a density of the material based on the cross-sectional area measurement, the speed of the conveyor, and the weight.

9. A method as defined in claim 8, wherein the material includes product and tare, the product having a designated product density and the tare having a designated tare density, the method further comprising the act of estimating the weight of the product.

10. A method as defined in claim 9, wherein the step of estimating the weight of the product comprises the acts of:
based on the estimated density of the material, the designated product density and the designated tare density, estimating a weight ratio of product to tare; and
based on the weight ratio and the weight of the material, estimating a weight of the product.

11. A method as defined in claim 9, wherein the material is assumed to have a designated packing ratio, the act of estimating the weight of the product comprising the steps of:
based on the estimated density of the material, the designated product density, the designated tare density, and the designated packing ratio, estimating a weight ratio of product to tare; and
based on the weight ratio and the weight of the material, estimating a weight of the product.

12. A method as defined in claim 9, wherein the product is a harvested crop, the method further comprising the act of selecting the designated density by measuring the density of a sample of the harvested crop.

13. A system as defined in claim 8, wherein the distance sensors of the array comprise ultrasonic distance sensors.

14. A system as defined in claim 13, wherein the ultrasonic distance sensors are positioned generally linearly in the array.

15. A system as defined in claim 13, wherein the array of distance sensors is oriented at an acute angle with respect to a direction of motion of the conveyor.

16. A system for measuring the density of material carried on a conveyor, comprising:
an array of distance sensors displaced from the conveyor, wherein each of the distance sensors is situated to obtain a height measurement of a portion of the material with respect to the conveyor;
means for sensing a speed of the conveyor;
processing means for estimating a cross sectional area of the material based on data generated by the array of distance sensors;
means for sensing a weight of at least a portion of the material; and
means for estimating a density of the material based on the cross-sectional area measurement, the speed of the conveyor, and the weight.

17. A system as defined in claim 16, wherein the distance sensors of the array comprise ultrasonic distance sensors.

18. A system as defined in claim 17, wherein the ultrasonic distance sensors are positioned generally linearly in the array.

19. A system as defined in claim 17, wherein the array of distance sensors is oriented at an acute angle with respect to a direction of motion of the conveyor.

20. A system as defined in claim 16, wherein the means for sensing a speed of the conveyor comprises a shaft speed sensor that senses an angular speed of a shaft that rotates as the conveyor moves.

21. A system as defined in claim 16, wherein the means for sensing a weight of at least a portion of the material comprises a load cell positioned with respect to the conveyor so as to be capable of measuring a weight of a portion of the material positioned over a particular segment of the conveyor.

22. A system as defined in claim 16, wherein the means for sensing a weight of at least a portion of the material comprises a load cell positioned with respect to a conveyor assembly that includes the conveyor so as to be capable of measuring a combined weight associated with a combination including the conveyor and said at least a portion of the material.

23. A system as defined in claim 16, wherein the processor means further comprises means for subtracting a tare weight from the combined weight, so as to yield the weight of said at least a portion of the material.
